(19) United States
(12) Patent Application Publication
(10) Pub. No.: US 2009/0171973 A1
(43) Pub. Date: Jul. 2, 2009

(54) USER-GENERATED MULTIMEDIA CONTENT FROM MOBILE AND NON-MOBILE DEVICES

(75) Inventors: Paul J. GAGNE, Groton, MA (US); John R. CORKE, Acton, MA (US); Michael L. BAYER, Sudbury, MA (US); Simeon R. MARGOLIS, Lowell, MA (US); Matthew R. McDANIEL, Tyngsboro, MA (US)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: RPM Communications, Inc., Maynard, MA (US)

(21) Appl. No.: 12/169,284

(22) Filed: Jul. 8, 2008

Related U.S. Application Data
(60) Provisional application No. 60/958,804, filed on Jul. 9, 2007.

(51) Int. Cl. G06F 17/30; G06Q 99/00

(52) U.S. Cl. 707/10; 705/1; 707/E17.009; 707/103 R; 707/E17.019; 707/E17.101; 707/E17.055

(57) ABSTRACT

A multimedia content system operates to manage mobile blogs created by users of communication devices. The mobile blogs may include content objects, which may be formed of audio components, text components, image, and/or video components. The various components may be formed from features of the communication devices. A user operating a mobile and/or non-mobile communication device may contact the system and provide one or more content objects for a mobile blog. The user may specify or create a community for accessing the mobile blog, and the multimedia content system publishes the blog for the community. Members of the community may view, edit, or augment the content objects of the mobile blog. Augmenting commands may be done through text messaging, email, or voice prompts. Users may access the mobile blogs through various communication devices. The content objects of the mobile blogs may be shared between users and indexed for easy retrieval.

### CROSS REFERENCE TO RELATED APPLICATION

This application claims priority to U.S. Provisional Patent Application No. 60/958,804, filed Jul. 9, 2007 and entitled “System and Method for User-Generated Multimedia Content from Wireless Devices,” the entire contents of which is incorporated by reference herein.

### BACKGROUND

Communication devices, such as mobile communication devices, may be utilized to create, transmit, receive, and store various types of electronic information, including multimedia content, such as images, audio, video, and/or text. Email and voicemail systems allow for users of various types of communication devices to access electronic information from multiple sources. Such systems may receive electronic information, store the electronic information, and make the electronic information accessible to users. The systems may also provide users with a notification related to the electronic information.

The ability to easily receive, store, index, and make accessible electronic information in a flexible form and format is a highly desirable aspect to users of mobile communication devices. Additionally, a capability for users to easily determine access rights to the electronic information, an ability to modify the electronic information, and a capability to store and retrieve multiple forms of the electronic information with the same mobile communication device or with other devices or networks are advantageous aspects. Further desirable features include a notification scheme for indicating availability of electronic information and an indexing feature that allows for titles, tags, dates, or other descriptors to be applied to the electronic information.

Accordingly, in light of the above considerations and limitations, an improved mobile communication system and method is desired.

### SUMMARY

A multimedia content system allows for users of various mobile communication devices to create a mobile blog. The multimedia content system further allows users to provide access to the mobile blog to a community of users, and index, augment, annotate, edit, enhance, and share the mobile blog. The mobile blog may include various content objects, which may be audio components, image components, video components, link components, file components, and/or text components. A mobile blog entry, which may include one or more components, may be created using the resources of a particular mobile communication device.

When a creating user sends a content object to the multimedia content system, a registration or identification process with the creating user may be performed. After the creating user is registered and/or identified, a community of various users may be identified by the creating user. The community may include those users who the creating user wishes to provide access to the mobile blog. The multimedia content system may then publish the content object for the community. The content object may be associated with a previous content object created by the creating user, or the content object may begin a new content object.

### BRIEF DESCRIPTION OF THE DRAWINGS

The foregoing summary and the following detailed description are better understood when read in conjunction with the appended drawings. Exemplary embodiments are shown in the drawings, however, it is understood that the embodiments are not limited to the specific methods and instrumentalities depicted herein. In the drawings:

FIG. 1 is a block diagram representing an exemplary multimedia content system.

FIG. 2 is an exemplary call flow for creating audio content, in accordance with an embodiment.

FIG. 3 is a flow diagram illustrating an embodiment of a method of creating a mobile blog.

### DETAILED DESCRIPTION

A mobile blog may contain multimedia content generated from mobile communication devices and/or non-mobile communication devices. A mobile blog may contain multiple entries from multiple users of mobile communication devices, or other devices, and each entry may include text content, audio content, video content, and/or image content. A mobile blog entry may be created using the resources of a particular mobile communication device as well as the resources of a particular non-mobile communication device.

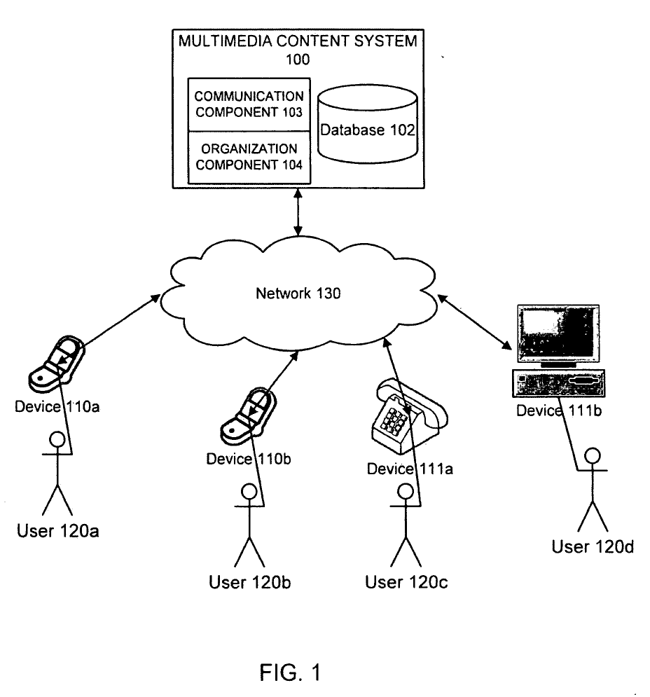

With reference to FIG. 1, a block diagram illustrates a multimedia content system 100. Mobile communication devices 110, such as device 110a and device 110b, and non-mobile communication devices 111, such as device 111a and device 111b, associated with users 120, may have access to the multimedia content system 100. Four users 120a, 120b, 120c, and 120d are shown with devices 110a, 110b, 111a, and 111b, respectively. Fewer or more users 120 and devices 110 or 111 may be used with the multimedia content system 100. The multimedia content system 100 may operate to store and organize multiple mobile blogs as generated by users 120. The multimedia content system 100 may include a database 102 for storing the mobile blogs. The mobile communication devices 110 or non-mobile communication devices 111 may communicate with the multimedia content system 100 over a network 130, such as the internet, a telephone network, or other network. A communication component 103 of the multimedia content system 100 may operate to receive and transmit communications between the network 130 and the system 100. The communication component 103 may provide and retrieve information to and from the database 102. The multimedia component system 100 may also include an organization component 104 for managing the mobile blogs.

A mobile blog may be organized around a community of users 120. Membership in a community allows for the users 120 to access and contribute to the mobile blog. The users 120 may be users of various mobile communication devices 110, such as cellular telephones or wi-fi telephones, or various non-mobile communication devices 111, such as computers or landline telephones. Various definitions may be applied to create the community. For example, one community may allow any user 120 of a communication device 110 or 111 to participate in the mobile blog. In another example, a user 120 may be required to sign up to gain access to and participate in the mobile blog. Alternatively, the community may be created by request, where entry into the community is approved by a user 120 who is already a member of the community. In another embodiment, a subscription process may be required to join the community, which may include payment or other registration criteria.

A content object may include text content, audio content, video content, link content, file content, and/or image content and may be an entry of the mobile blog. A content object may be associated with a content creator (one of the users 120) and published on the internet and/or telephone network for access by the designated community, as managed by the multimedia content system 100. When the content object is created, the content creator may designate the community or communities that may have access to the content object by, for example, designating attributes to be associated with the content object. The attributes may be entered, for example, using an interactive voice response script and/or by entering a formatted text message and sending it to the multimedia content system 100 using a transport facility over the network 130.

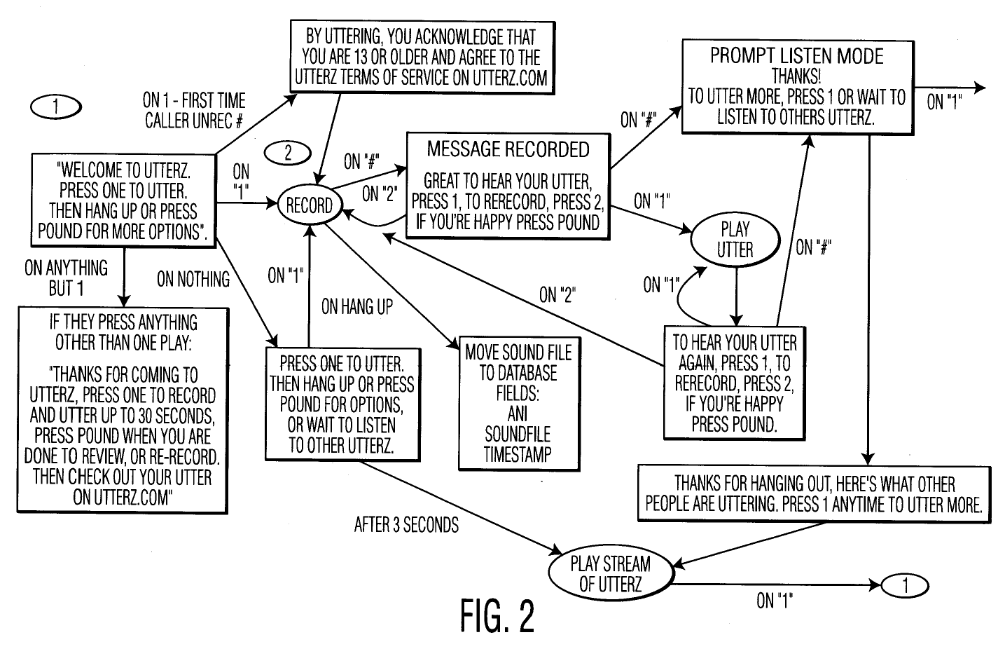

Audio content in a mobile blog entry may be captured using a cellular telephone or other device 110 or 111 capable of capturing audio signals. The audio content component of the content object may be created using a phone-based script that prompts the user 120 to enter audio content for the mobile blog entry by speaking into the device 110 or 111. FIG. 2 is an example call flow for creating audio content for a mobile blog entry. The audio content component may also be the conversation of two or more participants who have been connected together by a phone-based script or a web-based user interface and connected at the same time to a conferencing system capable of creating an audio recording of their conversation. The audio recording can then be used as an audio content component for a mobile blog entry. The audio content component may also be uploaded directly to the system 100 via web connection, sent as an attachment in an email, or by other electronic means, over the network 130.

When the audio content is received by the system 100, it may be associated with a previously created content object or a new content object. New audio content may be associated automatically with a content object based upon the age of the content object when the new audio content arrives. For example, if the new audio content arrives within a predefined time window from when the previous content object was created or accessed by the user 120, the audio content may be associated with the previous content object for that user 120. If the audio content arrives after the predefined time window has elapsed, then the audio content may be associated with a new content object. The user 120 generating the audio content for the mobile blog may be provided an interface, such as an internet and/or phone based interface, to make adjustments if necessary. For example, if the user 120 generates and sends audio content within the predefined time window but desires that the audio content be associated with a new or other content object, the user 120 may indicate this adjustment using an appropriate command available through the interface.

Image content or video content may be captured by a camera-enabled communication device 110 or 111. The image or video content may be forwarded to the system 100 using an email address, SMS short code, or other addressing mechanism. When the image content or the video content is received by the system 100, it may be associated with a previously created content object or a new content object. New image content or video content may, for example, be associated automatically with a content object based upon the age of the content object when the image or video content arrives. If the image or video content arrives within a predefined time window, the content may be associated with the previous content object for that user 120 generating the image or video content. If it arrives after the predefined time window has elapsed, then the image or video content may be associated with a new content object. Instead of an automatic association, the user 120 may indicate their choice of association with a new content object or a previously created content object.

Text content in a mobile blog entry may be captured using text messaging capabilities (such as SMS, IM, or text-to-speech) of a cellular telephone or other mobile communication device 110 or non-mobile communication device 111, as generated by a user 120. Text content may include a text message or an email message, for example. Text content may be sent to the multimedia content system 100 using email, SMS text messages, or other messaging based delivery mechanisms over the network 130. By using a “tag=value” format, a user 120 can set title and description fields, tags, and other text fields of a content object. When the text content is received by the system 100, it may be associated with a previously created content object or a new content object depending on the arrival time of the text content. If the text content arrives within a predefined time window, then the text content is associated with a previous content object created by the user 120. If it arrives after the predefined time window, then the text content may be associated with a new content object for the mobile blog. Regardless of the time window, the user 120 may indicate their choice of association of the text content with a new content object or a previously created content object.

When generating content and sending it to the multimedia content system 100 for inclusion in a mobile blog, the user 120 may not be known by the system 100. If the user is known by the system 100, the user 120 may have, for example, previously registered for an account using an internet site accessible using a device 111, such as through a web browser, or using a mobile communication device 110, such as a telephone, capable of transmitting alphanumeric or speech information that the system 100 may use to uniquely identify the user 120.

A user 120 may access the multimedia content system 100 using a device 110 or device 111 that transmits identifying information, such as a caller identifier or automatic number identifier (ANI), which is known to the system 100. Thus, the system 100 may then register the user 120 and begin a session with the user 120. If there is no such identifying information for the device 110 or 111, the system 100 may prompt the user 120 for such information (such as an account name and password). If there is no identifying information at all, the system 100 may create an account for the user 120 and begin a communication session with the user 120. The user 120 may register for an account at a later time, at which time the information communicated from the user 120 will be linked to their account.

A user 120 may store information with the system 100 prior to entering the registration process, and such information may be uniquely identified to have been received from the user 120. For example, audio information may be recorded using the same phone number used by the user 120 at registration. The multimedia content system 100 may operate to link the information to the user 120 in the database 102 using information that is previously known and information for example, a caller identifier that is entered or obtained during registration.

Once a session has been established between a user 120 and the multimedia content system 100, the user 120 may store and retrieve information from the system 100. The information may be audio information, text information, image information, or other information. Such information may be combined with other information. For example, a voice message may be associated with an image, descriptive text, and/or tags.

A user 120 may access and/or control features of the system 100 through various commands. The commands may be issued through any number of mechanisms, including but not limited to voice control, text message, email message, instant message (IM) and/or dual tone multiple frequency (DTMF) tones. Such commands may be used by the system 100 to augment the information stored in the database 102, arrange for its delivery and/or distribution to other users 120, or to perform various other tasks.

Using the command features, a user 120 may augment information already stored in the database 102. For example, if a voice message is already stored in the database 102 by the user 120, the user 120 may instruct the system 100 to create a title, tag, and/or other identifying information or to add a picture or other media to the information. The augmenting information may be sent to the system 100 by the user 120 either before or after the initial information has been sent to the system 100.

As an example, but not sole use, of the multimedia content system 100, a user 120 may call the system 100 using a telephone (for example, mobile communication device 110) and may leave an audio recording on the system 100, which is stored in the database 102. The system 100 may index the audio recording with the caller identifier (CALLERID) of the telephone used to record the message. The user 120 may then send a text message to the system 100 with augmenting information. The text message may contain any or all of a subject, message text, one or more photos or videos, or one or more audio attachments. The text message may be sent by email, SMS, MMS, IM or any other means. The system 100 may then create an index to the augmenting information which identifies it as coming from the CALLERID and link it to the voice message. The information may then be presented, combined with the augmenting information, to any other user 120 accessing the information. For example, the voice message may be presented with a title, tags, and a picture through a player presented on a web browser.

Commands in text messages may be used as control methods for the multimedia content system 100. Such a method may use various reserved commands and/or a unique syntax of a message to control the system 100. For example, a user 120 may send a text message to the system 100 with a subject, body text, and/or a picture, intending it to augment a content object for a mobile blog already stored in the database 102. The system 100 may append such information to existing information as follows: the subject line in the text message may become the title of the information, the body text may become tags (indices), and the picture may be appended to the voice message. The commands noted may be sent to the system 100 either before or after the augmenting information is sent. Other augmentation schemes are possible.

Additional commands may be sent to add, modify, or delete information, notify other users 120 as to the placement of information, access indexes of information, and/or receive help on the various features and functions available. The commands may be sent by text message, email, voice control (for example, speech recognition technology), and/or DTMF tones generated by a communications device 110 or device 111.

The information may be retrieved by a user 120 in various ways, either by a web browser, a telephone interface, or a player. A user may retrieve the information using a web browser interface provided by the system 100. Such interface may provide the retrieving user 120 with various preference criteria to control the indexing, ordering, and selection of information.

The user 120 may also create a link to the site using a player provided by the system 100 and place the link on another web site. When activated, the link may communicate with the system 100 to present the information in a format appropriate to the linked-from site. For example, the user 120 may copy a player from the system 100's web site, paste it onto their personal web page, and then another user 120 accessing the player on the user's web site could activate the player to retrieve the recording, titles, tags, and pictures, without ever connecting directly to the system 100. Links may exist in a plurality of formats and provide a plurality of functions. For example, one link may retrieve only certain information or certain types of information, another link may continually retrieve the most recent information, and a third link may retrieve information related to a certain group, topic or information meeting a particular criteria. Links may also provide a communications channel back to the system 100. For example, a player may provide a mechanism for the user 120 to select the specific criteria a player should use to retrieve information from the system 100. As another example, a user 120 may input data, such as tags, ratings, or comments, that may annotate the information stored by the system 100 and that is made available for later retrieval by other mechanisms.

The system 100 may also provide a telephone interface for retrieving information. For example, a user 120 may call the system 100 and access information they stored or stored by other users 120. Audio content may be delivered by playing it over a phone device. Text-based information may be delivered by “text-to-speech” or by sending it as a text message to the retrieving user 120, based on the preference criteria set by the retrieving user 120. Picture and video information may be sent to the user 120 by MMS or other means available to the particular communication device 110. The information may be delivered using one or more indexes based on the preference criteria set by the user 120, for example, by date, by user, or by popularity. The information may alternatively be delivered in an order determined by the system 100.

The system 100 may also provide other means for retrieving information. For example, the system 100 may present a really simple syndication (RSS) feed making all information, or selected information, available for retrieval on other web sites or locations. Such a feed may use various methods to select the desired information to be presented on the web site, including the use of specialized uniform resource locator (URL) codes or other schemes.

In addition, the multimedia content system 100 may provide for the grouping of users 120 and information to aid in the storage, indexing, and retrieval of information. A user 120 may set up groups of users 120 who are identified by a unique key or none at all. The users 120 in a particular group may share a collection of information. For example, a user may set up a collection of messages, pictures, text, and other media in an album.

A user 120 may select certain users 120 who have access to the album, identifying them individually, or associating them with a group. The group list may be accessible only to the user 120, or to the entire group. The user 120 may allow the group to retrieve information only and/or to modify, add, or delete information stored by the system 100. The originating user 120 may restrict access to the information by user 120 or by group, or any combination, or the user 120 may allow unrestricted access to the information.

In addition, the system 100 may provide for the collection of feedback from users 120. Such feedback may be used by the system 100 to provide additional indexes to the information. For example, the information may be indexed by the number of users 120 that retrieve the information, a quality or other rating collected from retrieving users 120, the user 120 who generated it, the popularity of the user 120 who generated it (based on other criteria, such as the ratings or number of retrievals of their other information managed by the system 100), or any number of tags created by the initiating user 120 or any retrieving user 120.

The multimedia content system 100 may use an algorithm for calculating the popularity, quality, or other characteristics of the information based on how it is used. For example, the system 100 may collect data indicating that retrieving users 120 do not listen to an entire message; instead, they skip to another message. Such data may suggest that the recording is of lower quality than another message which is generally listened to in its entirety, and the system 100 may use such data to create indexes to the information which determine how it is presented to other users 120.

Information, such as content objects, may also be organized by way of links to other information, forming an index. For example, information may be stored that is related to one particular topic or sent by a first user 120. A second user 120 may retrieve information and then create additional information as a “reply,” intended to be distributed in connection with the original information. Other users 120 may similarly create an indexed version of such information. For example, users 120 could engage in a “chain story” by way of the system 100, with each user 120 posting additional parts to the story intended to follow the postings which precede it. For further example, one user 120 could operate a “question and answer” forum, by alternatively posting, soliciting feedback, and then responding to the feedback, in an interaction with other users 120 that are either known or unknown (or any combination) to the original user 120. The system 100 may allow replies across multiple devices 110 or 111 such as web browsers and mobile phones. The system 100 may maintain an index as to what information a user 120 has already retrieved. For example, a participant in the “chain story” noted above may listen to the entire story or just a portion they have not yet heard.

The multimedia content system 100 may perform various analyses and enhancements to the content object of a mobile blog. For example, the fidelity of audio recordings from telephones may be of low quality as a result of reception issues, background noise, and/or variations in speech and volume. The system 100 may use certain technologies, either integrated within the system 100 or acquired from a third party, to enhance the quality of audio recordings. The system 100 may also use audio or visual indexing tools on information stored in the database 102. Such tools may be used to create an index to such information which may be searched by users.

In addition, the system 100 may use audio transcription tools, such as speech recognition tools, to convert audio recordings to text. Converted text may them be distributed in connection with, or separately from, the original information. The multimedia content system 100 may alternatively use text-to-speech tools to convert text input to audio for playback using a plurality of devices, including telephones.

In addition, the system 100 may use text-converted audio to create various indices used by organization component 104. For example, the individual words within the audio recording may be indexed, such that a user 120 may retrieve the audio recording based on a search of relevant audio recordings containing a particular word. In addition, meta-indices could be created to associate related indices. For example, an audio recording containing the words “apple” and “orange” may be indexed with the meta-index word “food” within the organization component 104, and a user 120 may retrieve the audio recording by searching for the related term.

A personalized web page may be provided for a user 120. The web page may have a unique key as an identifier. The web site may present the information, such as content objects, sent by the user 120 to the system 100, as well as annotations, feedback and other information from network contacts or groups and selected information the user 120 desires to include on the personalized page. The personalized page may be linked to or by another personalized page, such as on another web site, or in an email attachment.

The multimedia content system 100 may also prepare content for delivery to a user 120 based on identifying information and may then deliver that information in a format which is appropriate to the device 110 or the device 111 with which the user 120 chooses to access the system 100. Any unique identifying information known to the multimedia content system 100 may be used for this purpose including but not limited to phone number, the user's ID within the content system 100, and name of a group within the content system 100. For example, a user 120 may have a telephone number 123-456-7890. The system 100 may allocate a unique identifying address to that telephone number, for example, “1234567890@system_{—}100.com.” Any content directed to that address may then be prepared for delivery to that user 120. If the user 120 accesses the system 100 by telephone, then the system 100 may play the content to the user 120 over the telephone. Or if the user accesses the system 100 by web browser, then the system 100 may deliver the content to the user 120 via appropriate browser tools. The user may also set up a “forwarding” address for the unique identifying address, such that the system 100 may deliver the content to another device or address automatically or at the command of the user 120.

This mechanism may be used by the user 120 to prepare content accessed anywhere on the internet or stored electronically for delivery to the device 110 or the device 111 of their choice. For example, some audio content is stored and delivered in the form of “podcasts.” A user may select a podcast and forward it using any means, including email, to their unique identifying address. Then, when they access the system 100, for example, from their cell phone while away from their computer, they may listen to the podcast from their cell phone. Messages to and from the user's contacts may also be recorded, delivered, and accessed in this fashion.

The system 100 may also provide a means for a user 120 to prepare, forward, and retrieve content from other web sites, and in turn make that content available, in the form of a mobile blog, by telephone access or access via email, web browser, or other technology. For example, a user 120 may access the system 100, record a message through a telephone, and the system 100 may make that message available for retrieval on the user's web page at another web site, or the user 120 might direct the system 100 to make the message available for retrieval on another user's web site. This could be used as a means of placing audio, picture, or video comments, in addition to text comments, on another user's web site.

The database 102 of the multimedia content system 100 may include contact information related to each user 120. A first system 100 may connect with one or more other systems 100 which store content and/or messages. The contacts may be organized into groups by the user 120, the system 100, or a combination thereof. A user 120 may then access the group listing to direct content to the members of a particular group or group subset or provide access to others to direct content to those same members. For example, if a first user 120 created a group called “foo” containing the members 120a, 120b, and 120c, including identifying data for each member, the user may register with the system 100 and then direct a message or content to “foo@system_{—}100.com” and the system 100 may forward any such message or content to the members using the identifying data provided by the user 120. Another user 120 may access the same list with additional identifying information; for example, foo@user101@system_{—}100.com or any other such identification scheme.

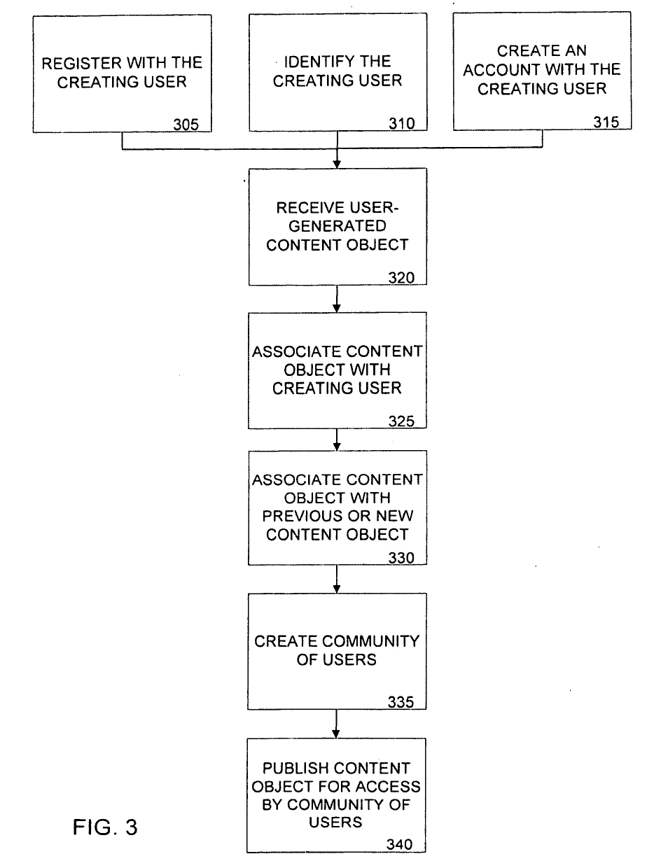

FIG. 3 is a flowchart illustrating an exemplary method of creating a mobile blog. The mobile blog may include multiple content objects that may be accessible to multiple users 120 of communication devices 110 or 111.

At 305, a creating user 120 may be registered with the multimedia content system 100 when contacting the multimedia content system 100. The registration may include an assignment of a unique user identifier. Alternatively, the creating user 120 may previously be registered with the system 100. In this case, at 310, the creating user is recognized by the system 100. Or, at 315, an account for the creating user 120 may be created, in which case a registration may not be performed.

At 320, a content object, generated by a creating user 120 using a mobile communication device 110 or non-mobile communication device 110, is received by the multimedia content system 100. The content object may include an audio component, an image component, a video component, a link component, a file component, and/or a text component. Additionally, the content object may be created using the resources of the particular mobile communication device 110 or non-mobile communication device 111 of the creating user 120. For example, a camera-enabled device may be utilized to capture a picture as an image component of the content object.

At 325, the content object received by the multimedia content system 100 is associated with the creating user 120. The association may indicate the user identifier assigned to the creating user 120, or other associations with the creating user 120 may be used.

At 330, the content object may be associated with either a previously-created content object or with a new content object. If the content object by the creating user 120 is received by the multimedia content system 100 before a predefined time window has elapsed, the content object may be associated with a previous content object created by the creating user 120. If the predefined time window has elapsed, then the content object may be associated with a new content object. The predefined time window may be defined by the multimedia content system 100 or by the creating user 120. The user 120 may be provided with an option to not implement use of a predefined time window and may instead select the content object to be associated with the new content object. Alternatively, the user 120 may override the predefined time window function and select the content object for association.

At 335, a community of users 120 is created. The creating user 120 may designate a pre-existing community for access to the content object when sending the content object to the multimedia content system 100. Alternatively, the creating user 120 may identify users 120 to be included in a new community. At 340, the content object is published and made accessible to the designated community of users.

As is apparent from the above, all or portions of the various systems, methods, and aspects may be embodied in hardware, software, or a combination of both.

The foregoing examples are provided merely for the purpose of explanation and are in no way to be construed as limiting. While reference to various embodiments are shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

1. A method of creating a mobile blog comprised of a content object for access to users of mobile and/or non-mobile communication devices, the method comprising:
receiving from a creating user a content object comprised of at least one component;
associating the content object with the creating user;
creating a community comprised of users; and
publishing the content object for access by the community.

2. The method of claim 1, wherein the at least one component comprises an audio component, an image component, a video component, a link component, a file component, or a text component.

3. The method of claim 1, wherein receiving from a creating user a content object comprised of at least one component comprises:
receiving captured audio signals from a communication device capable of handling audio signals.

4. The method of claim 3, wherein receiving captured audio signals comprises receiving audio content from the creating user utilizing a phone-based script that prompts the creating user to enter audio content

5. The method of claim 3, wherein receiving captured audio signals comprises receiving audio content from two or more participants connected to one another by a phone-based script and connected to a conferencing system, the audio content being a conversation between the two or more participants.

6. The method of claim 1, wherein receiving from a creating user a content object comprised of at least one component comprises:
receiving an image captured by a camera-enabled communication device.

7. The method of claim 1, wherein receiving from a creating user a content object comprised of at least one component comprises:
receiving captured text using text messaging capabilities of a communication device.

8. The method of claim 1, wherein receiving from a creating user a content object comprised of at least one component comprises:
receiving a video captured by a camera-enabled communication device.

9. The method of claim 1, further comprising:
associating the content object with one of (i) a previously-created content object or (ii) a new content object.

10. The method of claim 1, further comprising:
receiving from a creating user a designation of the community for access to the content object.

11. The method of claim 1, further comprising:
registering the creating user with a unique user identifier.

12. The method of claim 1, further comprising:
identifying the creating user based upon a previous registration.

13. A multimedia content system for managing mobile blogs, the multimedia content system comprising:
a database for storing mobile blogs created by users operating mobile communication devices and/or non-mobile communication devices and for storing information related to the mobile blogs;
a communication component for receiving and transmitting the mobile blogs and the information related to the mobile blogs from and to the mobile communication devices and/or the non-mobile communication devices and the database; and
an organization component for identifying users and for performing commands related to the mobile blogs;
wherein the mobile blogs comprises content objects of at least one of audio components, text components, video components, link components, file components, or image components.

14. The multimedia content system of claim 13, wherein the information related to the mobile blogs comprises at least one of (i) an identifier for the mobile blogs; (ii) an identifier for a creating user of the mobile blogs; (iii) a community of users designated to access the mobile blogs; and (iv) statistics related to use of the mobile blogs.

15. The multimedia content system of claim 14, wherein the communication component operates to notify the community of users upon receipt of a new mobile blog.

16. The multimedia content system of claim 13, wherein the communication component operates to communicate with the mobile communication devices over a network.

17. The multimedia content system of claim 13, wherein the organization component performs the command of augmenting a content object with identifying information and additional components.

18. The multimedia content system of claim 13, wherein the organization component performs the command of grouping users for a predefined access to the mobile blogs.

19. The multimedia content system of claim 13, wherein the organization component performs the command of enhancing a quality of the content objects.

20. The multimedia content system of claim 13, wherein the organization component performs the command of creating and managing indexes to the content objects.

21. The multimedia content system of claim 13, wherein the organization component allocates a unique identifying address for a user, and wherein the communication component formats content objects directed to the unique identifying address in a format consistent with the device of the user.

22. The multimedia content system of claim 21, wherein the unique identifying address is one of a phone number, the user's ID within the multimedia content system, and a name of a group to which the user is associated within the multimedia content system.
